(19) United States
(12) Patent Application Publication
(10) Pub. No.: US 2009/0089203 A1
(43) Pub. Date: Apr. 2, 2009

(54) Marriage Obligation Fulfillment Trust Method and System

(76) Inventors: Yung-Sung Chien, Taipei City (TW); Frank Kuen-Bao Ling, Kaohsiung County (TW); Yen-Tsen Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/241,014

(22) Filed: Sep. 29, 2008

(30) Foreign Application Priority Data
Sep. 29, 2007 (TW) 096136638
Jul. 10, 2008 (TW) 097126092

(51) Int. Cl. G06Q 40/00; G06Q 10/00

(52) U.S. Cl. 705/37; 705/35; 705/1

(57) ABSTRACT

By creating a self-determined interest rate platform, a trust fund can be transferred on the platform through a bidding process, so that risk oriented consigners can expand their credit to increase their investments, enhancing assurance to a beneficiary. On the contrary, this can increase interest income of discreet consigners through direct low-cost financial transactions. By creating a trust fund transaction platform, individual consignment funds can reflect the cash demand in the money market on the platform, so that the number of participants can increase the strength of marriage trusts and expand the trust fund market.

### BACKGROUND OF THE INVENTION

1. Field of the Invention

The present invention relates to financial e-commerce in a marriage trust area, using information technology to create a marriage obligation fulfillment trust method and system. The present invention uses the self-determined interest rate platform in Taiwan patent application No. 09611 6081, “Method and system for setting up a self-determined interest rate platform” and the law of large numbers to create a bidding platform to allow a consigner attending the bid platform to raise money through the bidding mechanism of the said platform so as to extend credit limit and investment. The consigner can also be conservative by not placing a bid and simply earning interest. The financial institution can earn a service charge by providing service in the bidding platform. A weak party in a marriage, such as a child or another member without issue can be designated as the trust beneficiary.

2. Description of the Prior Art

As the society evolves, the rising of divorce rate has become a concern in the global community. Taking Taiwan as an example, the crude divorce rate (the number of divorces occurring among the population of a given geographical area during a given year) in 2006 has reached 2.83%, which had risen 50% from ten years ago; divorced couple above the age of 15 reached 6.13%, signifying a 100% increase. In 2006, 177 couples got divorced in Taiwan every day, which had risen 48% from ten years ago. It was the fifth highest rate in the world, and the highest in Asia. After a divorce is occurred, how to provide protection to the weak party in a marriage, such as the children or one of the couple, has become an important issue in Taiwan society. Thus marriage trust has developed.

Traditionally marriage trust is a mechanism for consigning power of property management. A consigner entrusts his asset to a consignee so that the consignee can manage the asset of the consigner in a secure and conservative manner. The consignee receives all the power to manage the entrusted asset. The consigner has no right to participate in the financial planning and management of the entrusted asset. Thus the traditional marriage trust is a monotonous trust product. It can only satisfy conservative clients. The entrusted asset is not only unable to experience considerable growth, but is also unable to satisfy the demand of various clients.

U.S. Pat. No. 5,864,685, “Increasing Income Trust Computer Transaction System and Insured Investment Account System” uses a computer system or a data process system to manage an entrusted investment account. The assets in the entrusted investment account may be designated by a single trust contract, a plurality of trust contracts or annuity contracts. After a consigner dies, his beneficiary can receive a portion of the entrusted asset from the entrusted investment account. The patent enables a computer system to efficiently manage the assets designated by a plurality of trust contracts. However, the patent fails to provide interaction between the consigner and the management of the entrusted assets. And the patent is related to a closed-end trust contract. It lacks the ability to expand the client's credit and client base. Thus, the patent has its limitations.

US patent application publication No. 2004/0210460, “Marriage Insurance for Protecting against Divorce” discloses means to include investment in a marriage insurance policy. Though it makes improvement in the investment portion of a unit-linked insurance policy, it is still under the structure of a traditional unit-linked insurance policy. When a policy owner faces an economic downturn, the policy owner still has to make investment continuously, being exposed to potential investment loss.

Taiwan patent application No. 09611 6081, “Method and System for Building an On-Line Self-Determined Interest Rate Platform” can be used to build the trust fund platform of the present invention. Through a direct financial bidding process, the consigner can either take advantage of the high interest rate in the savings portion of the paid insurance payments, or expand his credit to earn higher yield through investment. And the financial institution is free from taking interest rate risk, reducing the possibility of negative spread.

Though both patent applications disclose means to deal with a divorce thereby securing a marriage and protecting the children financially, they are both one-way financial products. They can only satisfy certain conservative clients, and lack the interaction of funds in a capital market. Thus they are still within the scope of a traditional marriage trust. The present invention develops a novel system and method to overcome the problems of the prior art. Instead of providing a closed-end trust contract, it provides an open-end marriage trust contract. It not only secures a marriage, but also enhances the interaction between the consigner and the management of the entrusted fund. Furthermore, it enables the consigner to expand his credit.

### SUMMARY OF THE INVENTION

The present invention provides a marriage obligation fulfillment trust method and system to overcome the aforementioned problems. The purposes of the present invention are as follows:

1. The present invention provides a protection to the weakest party (children) when a divorce occurs: Based on protecting the weak party in a traditional trust, the present invention provides a secure channel to earn high yield by savings or investments through expanding a consigner's credit. Thus the beneficiary can be protected, and the stability of the society can be improved.

2. The present invention establishes an interactive trust platform: The traditional trust is completely managed by the financial institution. Thus the management of the traditional trust is not transparent. The client cannot participate in the management of the traditional trust. In the network generation, a fair, reasonable and transparent interactive trust platform is generated.

3. The present invention is capable of expanding a client's credit: Generally, the traditional trust products cannot expand a client's credit. Either a savings trust or an investment trust, the performance (the yield of the consigner) is limited. The present invention uses the self-determined interest rate platform to expand the credit of the consigner so that the consigner can receive higher yield and protection.

4. The present invention provides the consigner with the decision-making power to make payments: The consigner has the power to determine an amount for placing a bid, make deposits according to the bid provided by the platform, or receive a total bid amount through a bidding process to generate a higher yield, enhancing the amount of the trust fund.

5. The present invention is an open-end trust product. It can satisfy risk oriented consigners of various levels whereas the traditional trust product can only satisfy conservative clients.

6. The present invention is operated through the self-determined interest rate platform. It reflects the market interest rate, and thus creates an indicative reference interest rate.

To implement the above purposes, the present invention sets up a marriage obligation fulfillment trust system. The system comprises a server. Through a communication means or the Internet network, the consigner links with the server through a user interface and exchanges instant information with the server in a secure system environment. The server then initiates a trust setup process, initiates a credit checking process, enables the bidding function of the self-determined interest rate platform, initiates the trust fund management, initiates the event identification, and initiates the fund maintenance. The system further comprises a database for storing data required for the above operations, storing results and updating data. The server comprises:

a trust setup module for receiving a marriage obligation fulfillment trust application of a consigner and storing the application in the database;

a credit checking module for assessing credit of the consigner, a value of a collateral, and a guarantor, and granting a bid limit to the consigner to place a bid in a self-determined interest rate platform accordingly, and storing a result in the database;

a bid module for operating and managing the self-determined interest rate platform, and storing a result in the database;

a trust fund management module for receiving a total bid amount from the bid module, converting the total bid amount into a trust fund according to a marriage trust contract, managing the trust fund, and storing a result in the database;

an event identification module for receiving events of the consigner, analyzing and determining the events, and storing a result in the database; and

a fund maintenance module for managing a cash flow of the marriage obligation fulfillment trust system, and storing a result in the database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for implementing marriage obligation fulfillment trust according to the present invention.

FIG. 2 is a flowchart of a consigner placing a bid.

FIG. 3 shows a marriage obligation fulfillment trust system according to the present invention.

### DETAILED DESCRIPTION

To implement the present invention, the embodiments are detailed hereinafter:

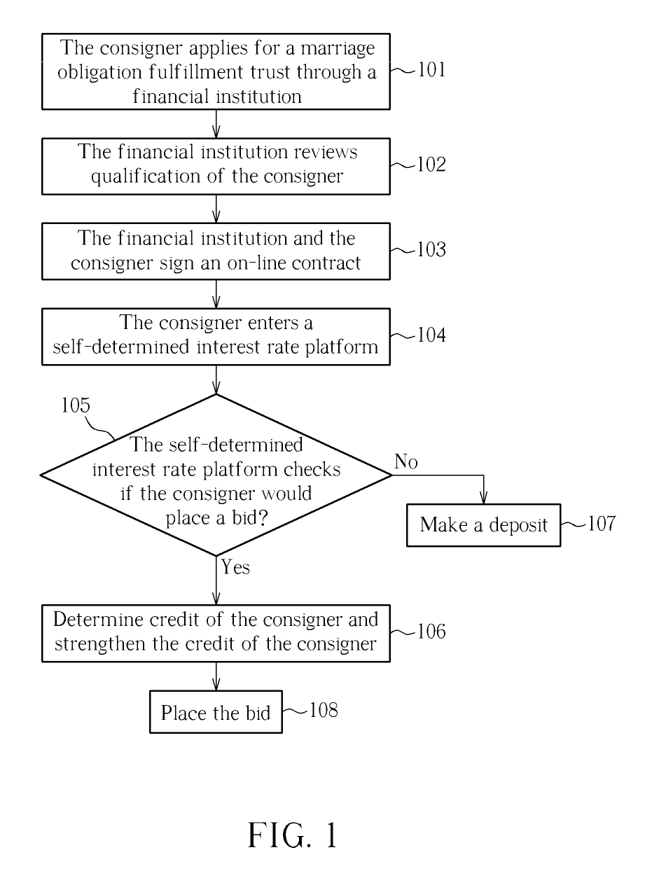

FIG. 1 is a flowchart of a method for implementing marriage obligation fulfillment trust according to the present invention.

Step 101: a consigner applies for a marriage obligation fulfillment trust through a financial institution;

Step 102: the financial institution reviews qualification of the consigner;

Step 103: after the financial institution qualifies the consigner, the financial institution and the consigner sign an on-line contract;

Step 104: after signing the on-line contract, the consigner enters a self-determined interest rate platform;

Step 105: the self-determined interest rate platform checks if the consigner would place a bid; if so, go to step 106; else go to step 107;

Step 106: determine credit of the consigner and strengthen the credit of the consigner; then go to step 108;

Step 107: make a deposit; end.

Step 108: place the bid; end.

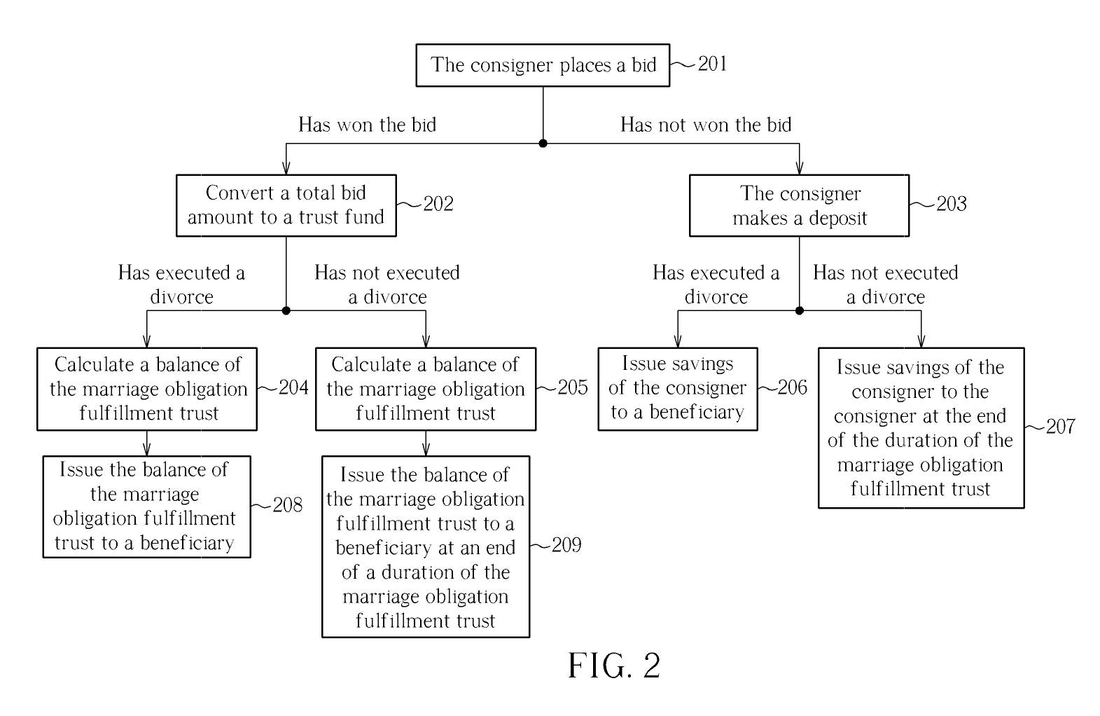

FIG. 2 is a flowchart of a consigner placing a bid.

Step 201: the consigner places a bid; if the consigner has won the bid, go to step 202; else go to step 203;

Step 202: convert a total bid amount to a trust fund; if the consigner has executed a divorce before a duration of the marriage obligation fulfillment trust ends, go to step 204; else go to step 205;

Step 203: the consigner makes a deposit; if the consigner has executed a divorce before a duration of the marriage obligation fulfillment trust ends, go to step 206; else go to step 207;

Step 204: calculate a balance of the marriage obligation fulfillment trust; then go to step 208:

Step 205: calculate a balance of the marriage obligation fulfillment trust; then go to step 209;

Step 206: issue savings of the consigner to a beneficiary; end.

Step 207: issue savings of the consigner to the consigner at the end of the duration of the marriage obligation fulfillment trust; end.

Step 208: issue the balance of the marriage obligation fulfillment trust to a beneficiary; end.

Step 209: issue the balance of the marriage obligation fulfillment trust to a beneficiary at an end of a duration of the marriage obligation fulfillment trust; end.

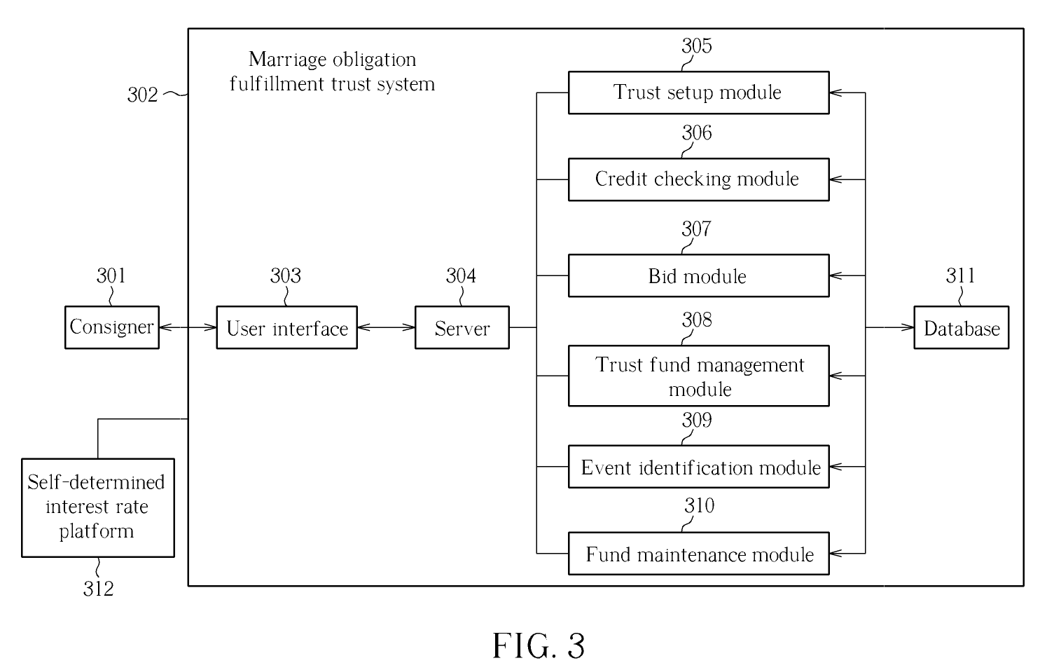

FIG. 3 shows a marriage obligation fulfillment trust system 302 according to the present invention. The system 302 comprises a server 304. Through a wired or wireless communications network, the consigner 301 uses a computer, cellular phone, PDA, etc. to link with the server 304 through a user interface 303 and exchange instant information with the server 304 in a secure system environment. The server 304 is coupled to a database 311 and various modules for storing data, information and results to respective portions of the database 311. The server 304 comprises:

a trust setup module 305 for receiving a marriage obligation fulfillment trust application of the consigner 301 and storing the application in the database 311;

a credit checking module 306 for assessing credit of the consigner 301, a value of a collateral, and a guarantor, and granting a bid limit to the consigner 301 to place a bid in a self-determined interest rate platform 312 accordingly, and storing a result in the database 311;

a bid module 307 for operating and managing the self-determined interest rate platform 312 by receiving a bid placed by the consigner 301, determining a winning bidder who has placed the highest bid, determining bidders who have not won the bid and are obligated to pay for the bid, and settling accounts and completing transactions according to the cash flow need of the consigner 301 in the self-determined interest rate platform, and storing a result in the database 311;

a trust fund management module 308 for receiving a total bid amount from the bid module 307, converting the total bid amount into a trust fund according to a marriage trust contract, managing the trust fund, and storing a result in the database

an event identification module 309 for receiving events of the consigner 301, analyzing the events, and storing a result in the database 311; and

a fund maintenance module 310 for managing a cash flow of the marriage obligation fulfillment trust system 302, and storing a result in the database. The cash flow refers to the savings deposited by the consigner 301, the trust fund converted from the total bid amount, the remittance of the trust fund, and the issuance of the trust fund or the savings to the consigner 301 or beneficiary.

An example of an embodiment of the present invention is described below:

Min and Sue had a wedding banquet and registered their marriage last year. Just recently Sue begot a baby and named him John. After John was born, the couple decided to purchase a marriage obligation fulfillment trust for John. The contract of the trust is as follows:

Marriage Obligation Fulfillment Trust

```
  Consigner: Min
  Consignee: XX Commercial Bank
  Beneficiary: children - first priority; Sue - second priority
    Trust duration: 7 years
    Trust conditions:
    1. trust fund is directed to the bid module unconditionally
    2. total bid amount is converted to the trust fund
      unconditionally, and is managed according to
      management conditions of the consignee
    Trust fund: determined by the lowest bid limit of each term, or
    the failed bid of the consigner of the self-determined
    interest rate platform
    Termination condition of the trust: the consigner has executed
    a divorce
The consigner of the trust should participate in the self-determined
interest rate platform of the consignee. The conditions are as follows:
Duration: 84 terms in 7 years (1 term per month)
Bid amount: NT$10,000
Lowest bid limit: calculated according to the floating rate of the 2-
      year term deposit rate of the designated bank
```

The purchase of the marriage obligation fulfillment trust provides a protection to John against the potential divorce of Min. It also provides an opportunity for Min to deposit his savings or raise cash to expand his investment. During the savings of Min, if Min has executed a divorce to satisfy the termination condition of the trust as specified in the contract before the duration of the marriage obligation fulfillment trust ends, John, the beneficiary, then can receive the savings deposited by Min so far. If Min has not executed a divorce to satisfy the termination condition of the trust before the duration of the marriage obligation fulfillment trust ends, Min can receive the total savings of NT $840,000. That is how the marriage obligation fulfillment trust works.

Suppose Min makes a deposit in each term of the first two years, and the average bid of each term is NT $1000, then in average the deposit of each term is NT $9000 in the first 24 terms. If in the 25^{th} term, Min mortgages his house to place a bid of NT $1200 and wins the bid, then Min can receive a total bid amount of NT $759,200 (NT $8,800×59+NT $10,000×24). The total bid amount includes the previous savings with interest and the mortgaged amount of NT $519,200. The total bid amount is to be managed by the trust fund management module 308 which will invest the total bid amount in a discreet manner to seek higher return. And Min will reimburse the mortgaged amount of NT $10,000 each term after winning the bid.

If Min and Sue are divorced in the beginning of the fourth year after purchasing the trust, John, the beneficiary, or his guardian can plead to the XX Commercial Bank for the trust fund. The trust fund management module 308 will calculate the balance of the investment. If the performance is steady and earns a 5% return, then the trust fund management module 308 will generate a total trust fund of NT $797,160 by adding the 5% return of NT $37,960 to the total bid amount of NT $759,200. Thus John can receive better financial protection from the growth of the investment. Though Min and Sue are divorced, Min still has to make periodic reimbursements each of NT $10,000 due to his bid, or else his mortgaged residence may be auctioned.

Further if Min has not executed the divorce within the 7-year duration of the trust, and earns an annual return of 5%, then at the end of the duration of the marriage obligation fulfillment trust, Min can plead for a sum of NT $968,953 (759,200×(1+5%)̂5). Therefore, it is clear that the marriage obligation fulfillment trust of the present invention not only provides reliable protection to the beneficiary, but it also expands the credit of the consigner to enhance the gain of the consigner.

Those skilled in the art will readily observe that numerous modifications and alterations of the device and method may be made while retaining the teachings of the invention.

What is claimed is:

1. A method for implementing marriage obligation fulfillment trust comprising:
a consigner applying on-line for a marriage obligation fulfillment trust through a financial institution;
the financial institution reviewing qualification of the consigner;
after the financial institution qualifies the consigner, the financial institution and the consigner signing an on-line contract;
after signing the on-line contract, the consigner entering a self-determined interest rate platform;
the self-determined interest rate platform checking if the consigner would place a bid;
if the consigner would place the bid, determining credit of the consigner; and
placing the bid.

2. The method of claim 1 further comprising strengthening the credit of the consigner.

3. The method of claim 1 further comprising if the consigner has won the bid, converting a total bid amount to a trust fund.

4. The method of claim 3 further comprising if the consigner has executed a divorce before a duration of the marriage obligation fulfillment trust ends, calculating a balance of the marriage obligation fulfillment trust, and issuing the balance of the marriage obligation fulfillment trust to a beneficiary.

5. The method of claim 4 further comprising providing a proof of relationship between the consigner and the beneficiary.

6. The method of claim 3 further comprising if the consigner has not executed a divorce before a duration of the marriage obligation fulfillment trust ends, calculating a balance of the marriage obligation fulfillment trust, and issuing the balance of the marriage obligation fulfillment trust to a beneficiary at an end of a duration of the marriage obligation fulfillment trust.

7. The method of claim 1 further comprising if the consigner has not won the bid, the consigner making a deposit.

8. The method of claim 7 further comprising if the consigner has executed a divorce before an end of a duration of the marriage obligation fulfillment trust, issuing savings of the consigner to a beneficiary.

9. The method of claim 8 further comprising providing a proof of relationship between the consigner and the beneficiary.

10. The method of claim 7 further comprising if the consigner has not executed a divorce before an end of a duration of the marriage obligation fulfillment trust, issuing savings of the consigner to the consigner at the end of the duration of the marriage obligation fulfillment trust.

11. The method of claim 1 wherein determining the credit of the consigner comprises the financial institution checking the credit of the consigner, and granting the consigner a credit limit according to the credit of the consigner.

12. The method of claim 11 wherein granting the consigner the credit limit according to the result of credit checking of the consigner comprises granting the consigner a bid limit according to the result of credit checking of the consigner.

13. The method of claim 1 wherein determining the credit of the consigner comprises the financial institution assessing a value of a collateral provided by the consigner, and granting the consigner a credit limit according to assessment of the value of the collateral.

14. The method of claim 13 wherein granting the consigner the mortgage limit according to the assessment of the value of the collateral is granting the consigner a bid limit according to the assessment of the value of the collateral.

15. The method of claim 1 wherein determining the credit of the consigner comprises the financial institution checking credit of a guarantor provided by the consigner, and granting the consigner a credit limit according to the credit of the guarantor.

16. The method of claim 15 wherein granting the consigner the credit limit according to the result of credit checking is granting the consigner a bid limit according to the credit of the guarantor.

17. A method for implementing marriage obligation fulfillment trust comprising:
a consigner applying on-line for a marriage obligation fulfillment trust through a financial institution;
the financial institution reviewing qualification of the consigner;
after the financial institution qualifies the consigner, the financial institution and the consigner signing an on-line contract;
after signing the on-line contract, the consigner entering a self-determined interest rate platform;
the self-determined interest rate platform checking if the consigner would place a bid;
if the consigner would not place the bid, the consigner making a deposit.

18. The method of claim 17 further comprising if the consigner has executed a divorce before an end of a duration of the marriage obligation fulfillment trust, issuing savings of the consigner to a beneficiary.

19. The method of claim 18 further comprising providing a proof of relationship between the consigner and the beneficiary.

20. The method of claim 17 further comprising if the consigner has not executed a divorce before an end of a duration of the marriage obligation fulfillment trust, issuing savings of the consigner to the consigner at the end of the duration of the marriage obligation fulfillment trust.

21. A marriage obligation fulfillment trust system comprising:
a database;
a server comprising:
a trust setup module for receiving a marriage obligation fulfillment trust application of a consigner and storing the application in the database;
a credit checking module for assessing credit of the consigner, a value of a collateral, and a guarantor, and granting a bid limit to the consigner to place a bid in a self-determined interest rate platform accordingly, and storing a result in the database;
a bid module for operating and managing the self-determined interest rate platform, and storing a result in the database;
a trust fund management module for receiving a total bid amount from the bid module, converting the total bid amount into a trust fund according to a marriage trust contract, managing the trust fund, and storing a result in the database;
an event identification module for receiving events of the consigner, analyzing and determining the events, and storing a result in the database; and
a fund maintenance module for managing a cash flow of the marriage obligation fulfillment trust system, and storing a result in the database.

22. The marriage obligation fulfillment trust system of claim 21 further comprising a user interface for communicating between a consigner end terminal with the server through the Internet.

23. The marriage obligation fulfillment trust system of claim 22 wherein the consigner end terminal comprises a personal computer, an automatic teller machine (ATM), an image phone, a voice phone or a personal data assistant (PDA).
